(19) United States
(12) Patent Application Publication
(10) Pub. No.: US 2006/0277344 A1
(43) Pub. Date: Dec. 7, 2006

(54) Information processing apparatus and controlling method thereof

(75) Inventors: Yoshiki Yasui, Hamura-shi (JP); Daisuke Yashima, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/355,169

(22) Filed: Feb. 16, 2006

(30) Foreign Application Priority Data
Jun. 2, 2005 (JP) 2005-162853

(51) Int. Cl. G06F 13/14

(52) U.S. Cl. 710/305

(57) ABSTRACT

According to one embodiment, a state shift of a state machine is stored in BIOS-ROM as history information and a state of the state machine is controlled by CPU to be shifted to a specific state or not to be shifted thereto, in accordance with the history information.

### CROSS-REFERENCE TO RELATED APPLICATIONS

This application is based upon and claims the benefit of priority from prior Japanese Patent Application No. 2005-162853, filed Jun. 2, 2005, the entire contents of which are incorporated herein by reference.

### BACKGROUND

1. Field

One embodiment of the invention relates to this invention relates to an information processing apparatus such as a computer and a method of controlling operations of the apparatus.

2. Description of the Related Art

Recently, a third-generation general-use I/O interconnection interface called PCI Express, for an information processing apparatus such as a computer has been noticed. PCI Express is a standard for making interconnection between devices via a communication path called a Link and is defined by PCI SIG (Peripheral Component Interconnect Special Interest Group). By the PCI Express standard, data transmission between the devices is executed by using packets.

In addition, a communication path control function which is capable of setting a Link in a low power state even if the device is in an operated state, is defined by the PCI Express standard. This communication path control function is called Active State Power Management (ASPM). The Link state is automatically set from the operated state to the low power state (standby state) by hardware when the Link is idle. If communications are required, the Link state is returned from the standby state to the operated state by hardware. By the ASPM function, wasted power consumption can be reduced during the idle period of the Link and the power consumption of the information processing apparatus can be reduced.

In relation to shift of LTSSM (Link Training and Status State Machine) of the PCI Express, if the Link is established, the state starts at Detect state and shifts to Polling, Configuration and L0. L0 is the general state. If the ASPM (Active State Power Management) is enabled, when no packets are transmitted or received during a certain period, the LTSSM shifts to L0s and L1 to attempt reducing the power consumption. When packet transmission and reception are restarted, the LTSSM shifts directly to the L0 state by FTS sequence if the state is L0s or to the L0 state via Recovery state if the state is L1. Due to difference in arrangement of PHY and MAC of two connected PCI Express component devices, errors caused by the state of the transmission path, and the like, however, the LTSSM does not return soon in a normal sequence, but has abnormality in the shift (Jpn. Pat. Appln. KOKAI Publication No. 2002-73226).

However, the technique of Jpn. Pat. Appln. KOKAI Publication No. 2002-73226 relates to PCI power management (PCI-PM) in which the ASPM does not exist and, mainly, to D3 shift of the PCI-PM. Return from the D3 shift of the PCI-PM is predicated on executing a reset by software or hardware. The PCI Express is characterized in that the ASPM corresponds to a low power state mode capable of autonomous shift and shifts to the low power state mode without software control. However, ambiguity relating to incorporation of the ASPM between the components causes unstableness of two component devices, waste of the power due to re-initialization of the Link, which result from enabling the ASPM. Since two component devices both correspond to the ASPM by the PCI Express standard, the ASPM Support in the Link Capability Status is enabled. In the case of such incorporation, it is not preferable to enable the ASPM.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an illustration showing an outer appearance of an information processing apparatus according to an embodiment of the present invention;

FIG. 2 is a block diagram showing a system configuration in the information processing apparatus according to the embodiment of the present invention;

FIG. 3 is a block diagram showing a connection of devices provided in the information processing apparatus according to the embodiment;

FIG. 4 is an illustration showing a Link state shift used in the information processing apparatus according to the embodiment;

FIG. 5 is a flowchart showing steps of ASPM control processing executed in the information processing apparatus according to the embodiment; and

FIG. 6 is a table showing history information of an abnormal state shift sequence.

### DETAILED DESCRIPTION

Various embodiments according to the invention will be described hereinafter with reference to the accompanying drawings. In general, according to one embodiment of the invention, an information processing apparatus comprises devices connected by a serial bus interface having a state machine shift for establishment of a communication path. The apparatus is configured to comprise storage means for storing a state shift of the state machine as history information and control means for controlling a state of the state machine to be shifted to a specific state or not to be shifted thereto, in accordance with the history information.

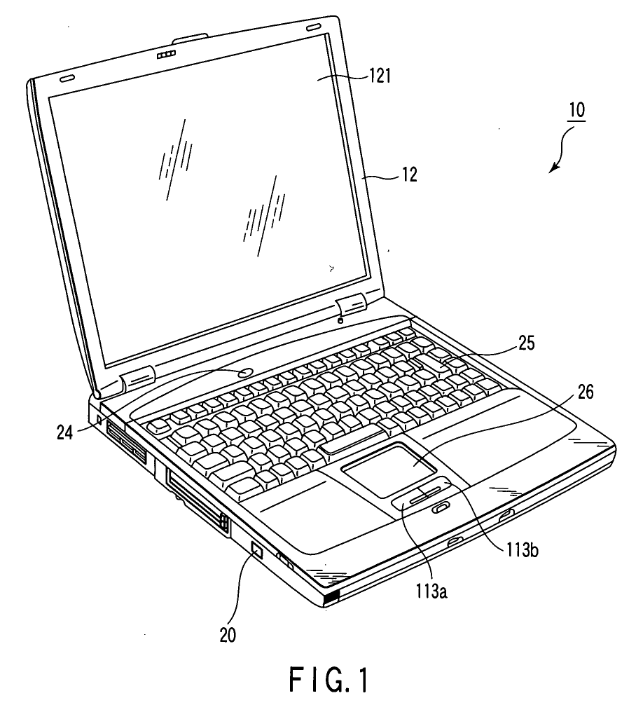

According to an embodiment, FIG. 1 shows an outer appearance of an information processing apparatus according to an embodiment of the present invention.

This information processing apparatus is implemented as a notebook-size computer 10 capable of being operated with a battery.

As shown in FIG. 1, the computer 10 is composed of a computer body and a display unit 12. A display device of LCD (Liquid Crystal Display) is incorporated in the display unit 12. A display screen 121 of the LCD is substantially centered on the display unit 12.

The display unit 12 is attached to the computer 10 so as to freely pivot between an opened position and a closed position. The main body of the computer 10 is a housing shaped in a thin box. A power button 24, an LED display unit (display means) 220, and a keyboard 25 are arranged on a top surface of the main body. A touch pad 26, two buttons 113a, 113b and the like are arranged on a palm rest of the main body.

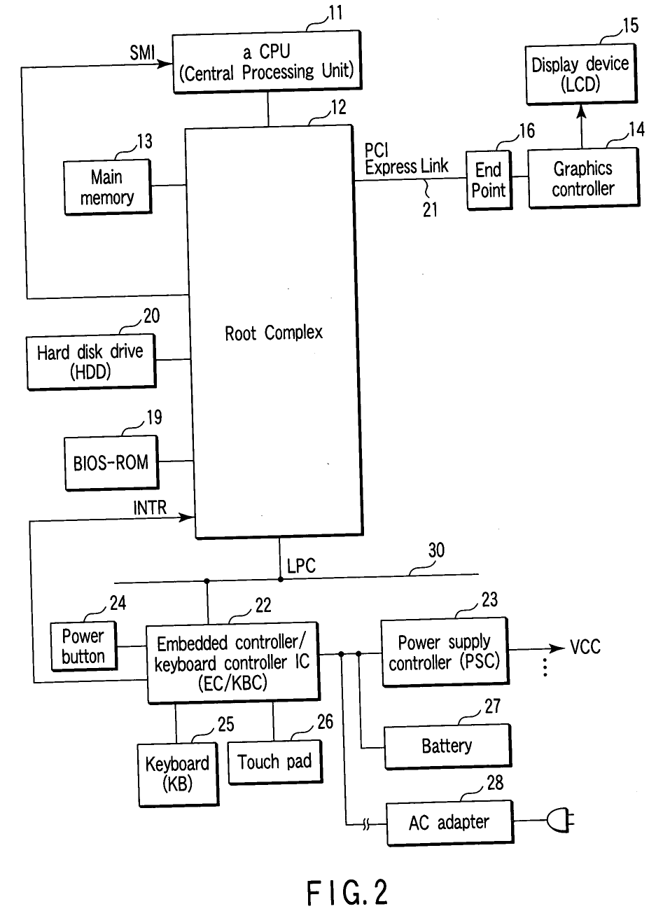

FIG. 2 is a block diagram showing a configuration of the computer 10.

The computer 10 comprises a built-in battery 27. When the computer 10 is not connected to an external power supply (AC power supply), the computer 10 is operated with the power of the built-in battery 27. When the computer 10 is connected to an AC adaptor 28, i.e. an external power supply (AC power supply), the computer 10 is operated by the external power supply (AC power supply). In addition, the battery 27 is charged by the external power supply.

As shown in the figure, the computer 10 comprises a CPU (Central Processing Unit) 11, a Root Complex 12, a main memory 13, a graphics controller 14, a display device (LCD) 15, an End Point 16, a BIOS-ROM 19, a hard disk drive (HDD) 20, an embedded controller/keyboard controller IC (EC/KBC) 22, a power supply controller (PSC) 23, a keyboard (KB) 25, a touch pad 26 and the like.

The Root Complex 12, the graphics controller 14, and the End Point 16 are devices (components) based on the PCI Express standard. Communications between the Root Complex 12 and the graphics controller 14 are executed via a PCI Express Link 21 arranged between the Root Complex 12 and the graphics controller 14. The PCI Express Link 21 is a communication path composed of a serial interface, including an upstream lane and a downstream lane.

The CPU 11 is a processor for controlling the operations of the computer, executing various kinds of programs (operating system and application programs) loaded into the main memory 13 by the HDD 20. The CPU 11 also executes the BIOS (Basic Input Output System) stored in the BIOS-ROM 19. The BIOS is a program for controlling the hardware. The BIOS also has SMI (System Management Interrupt) routine for dynamically permitting or prohibiting execution of Active State Power Management (ASPM) function defined by the PCI Express standard, in accordance with the operation mode of the computer. As described above, even if the device corresponding to the PCI Express standard is in an operated state (D0 state), the ASPM function can set the Link connected to the device in the low power state (standby state). Each of two devices interconnected via the Link has the ASPM function and can urge the Link state to shift between the operated state and the standby state in which power consumption is lower than that in the operated state, in accordance with whether the Link is in the idle state. This shift is automatically executed by the hardware.

The Root Complex 12 is a bridge device for making connection between a local bus of the CPU 11 and the End Point 16. The Root Complex 12 also has a function of carrying out communications with the End Point 16 and the graphics controller 14 via the PCI Express Link 21.

The graphics controller 14 is a display controller for controlling the LCD 15 employed as a display monitor of the computer.

The embedded controller/keyboard controller IC (EC/KBC) 22 is a one-chip microcomputer in which an embedded controller for power management and a keyboard controller for controlling the keyboard (KB) 25 and the touch pad 26 are integrated. The embedded controller/keyboard controller IC (EC/KBC) 22 has a function of turning on/off the power of the computer 10, in cooperation with the power supply controller (PSC) 23, in accordance with user operations of the power button 24. The embedded controller/keyboard controller IC (EC/KBC) 22 also has a function of detecting connection of the AC adaptor 28 to the computer and detachment of the AC adaptor 28 from the computer. When an event of connecting or detaching the AC adaptor 28 occurs, the embedded controller/keyboard controller IC (EC/KBC) 22 generates an interrupt signal (INTR) to notify the BIOS of the occurrence of the power management event. In response to the interrupt signal (INTR), the End Point 16 generates an interrupt signal (SMI) to the CPU 11. In response to the SMI, the CPU 11 executes the SMI routine of the BIOS. The SMI may be directly supplied from the EC/KBC 22 to the CPU 11.

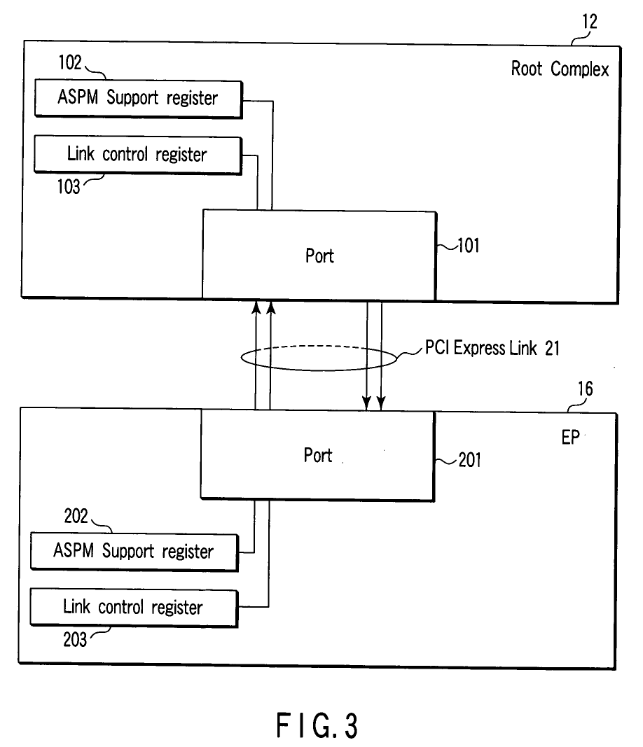

FIG. 3 illustrates connection between two devices based on the PCI Express standard. An example of the connection between the Root Complex 12 and the End Point 16 is explained here. The Root Complex 12 is called device #1 while the End Point 16 is called device #2.

The device #1 and the device #2 are interconnected via the PCI Express Link 21. The PCI Express Link 21 is a serial interface (serial bus) for making a point-to-point connection between the device #1 and the device #2. The PCI Express Link 21 includes a differential signal line pair for transmitting information from the device #1 to the device #2 and a differential signal line pair for transmitting information from the device #2 to the device #1. The information transmission between the device #1 and the device #2 via the PCI Express Link 21 is executed by using packets.

The device #1 has a port 101 connected to the PCI Express Link 21. Similarly, the device #2 has a port 201 connected to the PCI Express Link 21.

The port 101 has a transmitting unit for transmitting the data to the device #2 via the PCI Express Link 21 and a receiving unit for receiving the data transmitted from the device #2 via the PCI Express Link 21. Similarly, the port 201 has a transmitting unit for transmitting the data to the device #1 via the PCI Express Link 21 and a receiving unit for receiving the data transmitted from the device #1 via the PCI Express Link 21. If the state in which there are no data (valid data) transmitted via the PCI Express Link 21 continues for a certain period, each of the ports 101 and 201 detects that the PCI Express Link 21 is in the idle state. In this case, the ports 101 and 201 cooperate with each other to execute the processing of urging the state (Link state) of the PCI Express Link 21 to shift from the operation state to the standby state. In the standby state, for example, operations of each of the transmitting units and receiving units are stopped and the PCI Express Link 21 is not driven. The power consumption is therefore reduced.

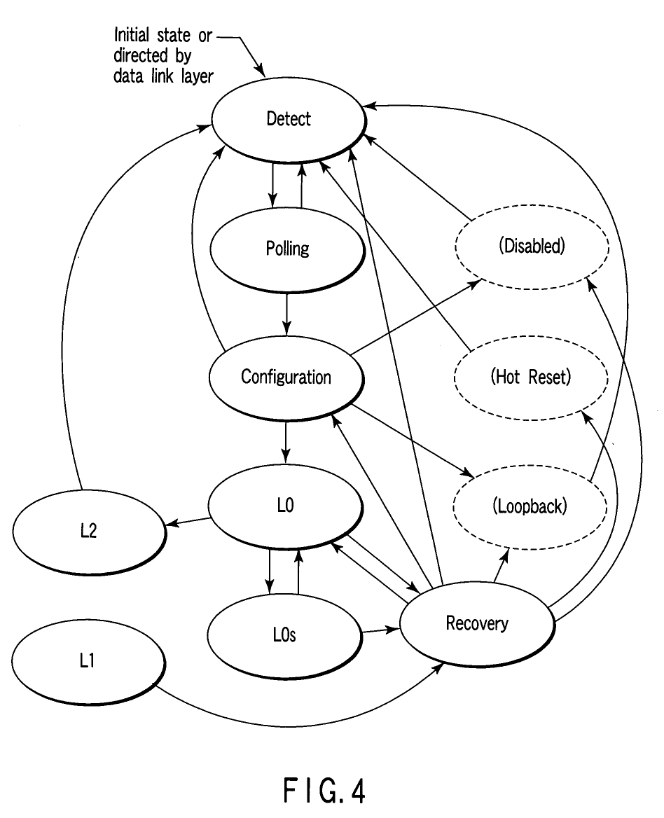

As illustrated in Link state shift of FIG. 4, Link states L0, L0s, L1, L2, Detect, Polling, Configuration, Disabled, Hot Reset, Loopback and Recovery are defined by the PCI Express standard. L0 represents the general operation state (active state). L0s, L1 and L2 are low power states in which the power consumption is small. The power consumption is reduced in order of L0s, L1 and L2.

Two standby states L0s and L1 are defined as low power states in which the PCI Express Link can shift when the PCI Express device is in the operation state. The power consumption in the standby state L1 is lower than the power consumption in the standby state L0s. The delay time required for return from L0s to L0 is shorter than the delay time required for return from L1 to L0. The PCI Express device needs to support at least L0s as the low power state in which the PCI Express Link can shift when the PCI Express device is in the operation state. The PCI Express device may support two standby states L0s and L1 as the low power states in which the PCI Express Link can shift when the PCI Express device is in the operation state.

If each of the ports 101 and 201 has data to be transmitted to the device of the other port, the ports cooperate with each other to execute the processing of returning current state (Link state) L0s or L1 of the PCI Express Link 21 to L0.

The device #1 comprises an ASPM support register 102 and a Link control register 103. The ASPM support register 102 and the Link control register 103 are provided such that the CPU 11 can make access thereto. The ASPM support register 102 has a field which represents the standby state supported as the ASPM by the device #1. The BIOS can recognize the standby state supported as the ASPM by the device #1 by making read access to the ASPM support register 102. The Link control register 103 has a field in which power management control information of instructing permission or prohibition of the execution of the ASPM function is stored. The BIOS can instruct the port 101 of the device #1 to permit or prohibit the execution of the ASPM function, by writing the power management control information in the Link control register 103.

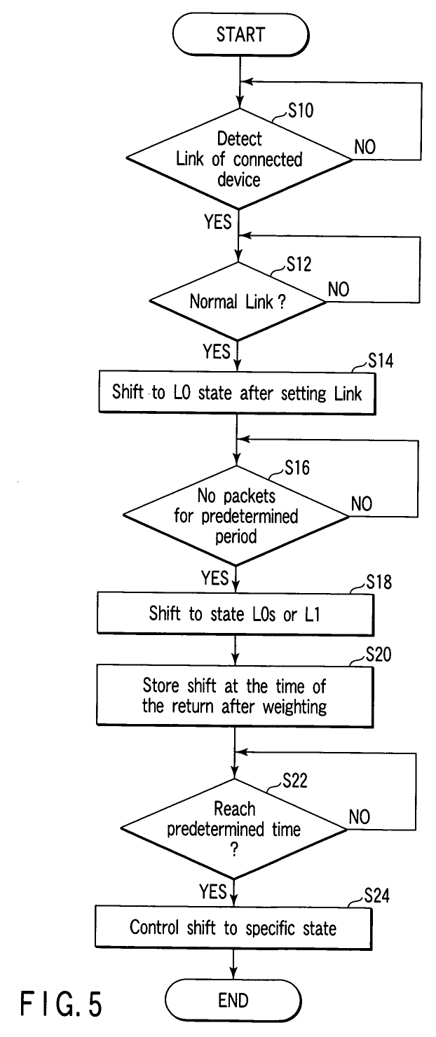

Next, steps of the control processing will be described with reference to the illustration of FIG. 4 and the flowchart of FIG. 5.

An initial state at the power-on is generally Detect state. In the Detect state, a Power Management Controller of the Root Complex 12 detects a Link of the device with which communications are to be made by the PCI Express in step S10. If the detection of the Link is succeeded, the Power Management Controller shifts to Polling state. In the Polling state, the Power Management Controller flows a specific signal (TS Ordered Set) over the Link to execute a test as to whether the Link can normally function, in step S12. If it is determined that the Link is normal, the Power Management Controller shifts to Configuration state. In the Configuration state, the Power Management Controller executes negotiation of Link width, Link number, Lane number and the like and mainly executes settings of the Link, in step S14. If the settings are normally completed, the Power Management Controller shifts to the general operation state, i.e. the state L0.

In the state L0, if packet transmission and reception are not executed for more than a certain period in step S16, the state of LTSSM (Link Training and Status State Machine) automatically shifts to the state L0s or L1 in step S18. In these states, the Link is suspended. If a request for packet transmission is generated in a higher layer (Data Link Layer or the like), the Link returns to the state L0. In a case where the Link is in the state L0s, the Link directly returns to the state L0 by FTS Sequence. In a case where the Link is in the state L1, the Link returns to the state L0 via Recovery state. These shifts are normal shifts.

On the other hand, failure of the negotiation may be caused since the connected components are different in packaging, the components are operated out of the PCI Express standard, and the like. Thus, problems that the FTS Sequence is failed in the state L0s, return from state L1 to the Recovery state is failed, and the like may occur. In these cases, the Power Management Controller follows the shift sequence of abnormal LTSSM state.

The Power Management Controller stores such a history of the shift sequence in the abnormal state in the storage means such as a register, flush memory or the like, in step S20.

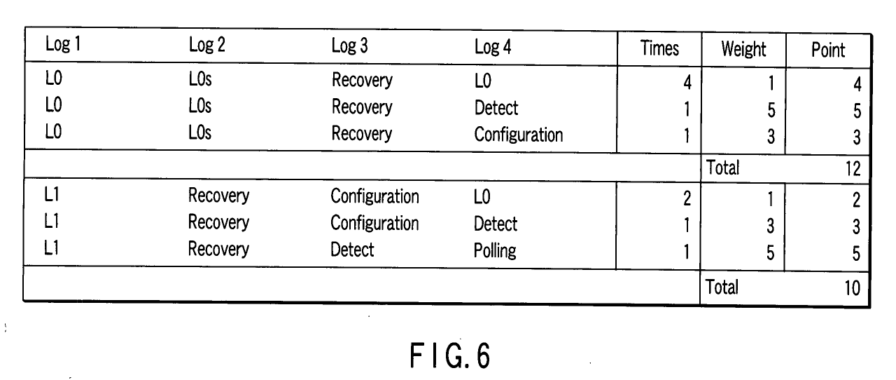

FIG. 6 is a table showing shift sequences in abnormal states.

Some examples of the shift sequences in abnormal states are:

L0 state>L0s state>Recovery state>L0 state,

L0 state>L0s state>Recovery state>Detect state,

L0 state>L0s state>Recovery state>Configuration state,

L1 state>Recovery state>Configuration state>L0 state,

L1 state>Recovery state>Configuration state>Detect state,

L1 state>Recovery state>Configuration state>Polling state.

The Power Management Controller stores histories of the number of times (Times), weight (Weight) and index value (Point), in relation to the above shift sequences.

For example, in the shift sequence of L0 state>L0s state>Recovery state>L0 state, the number of times (Times) is 4, the weight (Weight) is 1 and the index value (Point) is 4*1=4. In the shift sequence of L0 state>L0s state>Recovery state>Detect state, the number of times (Times) is 1, the weight (Weight) is 5 and the index value (Point) is 1* 5=5. Since the Detect state is a seriously abnormal state shift, the weight (Weight) is increased to, for example, 5.

In other words, the pattern of L0 state>L0s state>Recovery state>L0 state is a comparatively small abnormal shift. In general, when FTS is not normally succeeded, the state sequence often shifts to the Recovery state and returns to L0, for the reason that, for example, locking of PLL is delayed. On the other hand, in the case of the pattern of L0 state>L0s state>Recovery state>Detect state, the shift sequence further shifts from the Recovery state to the Configuration state. The processing of the TS Ordered Set is considered to be failed, which is a worse condition. Therefore, the abnormal state shifts are different in influence of problem, by the pattern of the state shift of the LTSSM. For this reason, the problem can be managed further effectively by weighting the problem by the pattern of the state shift of the LTSSM.

Similarly, as for the shift from L1, the pattern of L1 state>Recovery state>Configuration state>L0 state, is a comparatively small abnormal shift. On the other hand, the pattern of L1 state>Recovery state>Configuration state>Detect state and the pattern of L1 state>Recovery state>Detect state>Polling state cause a great influence. Thus, weighting can be executed in the shifts from L1, Similarly to the shifts from L0s.

Next, in step S22, the Power Management Controller discriminates whether or not the history of the shift sequence of the abnormal state stored in the storage means reaches a predetermined value. The predetermined value may be set on the basis of number of times (Times) and the index value (Point). The predetermined value may be a threshold value of a point per unit time. In this case, if an inconvenience temporarily occurs but falls within the threshold value, the shift sequence can effectively return to the general state.

If the Power Management Controller discriminates that the history of the shift sequence of the abnormal state reaches the predetermined value in step S22, the Power Management Controller restricts shift to a specific state in step S24. For example, the Power Management Controller sets the ASPM at Disable since retaining such an unstable state brings about no merits for the ASPM.

As described above, if the ASPM is not employed with the abnormal sequence, the L0 state only needs to be maintained, but the state shifts to the negotiation caused by the TS Ordered Set in the Recovery state or the Configuration state or, in a worst case, to Link detection in the Detect state. The Detect state may cause bad influences such as clear of Retry Buffer and loss of TLP. It is therefore considered that the ASPM of the PCI Express positively reduces the power consumption but has a disadvantage of lowering the stability of the Link.

As described above, maintaining such an unstable state of the Link brings about no merits for the ASPM and setting the ASPM at Disable is preferable in some cases.

In the present invention, when a number of abnormal state shifts of the LTSSM which result from the return from the ASPM occur at a great rate, the ASPM can be automatically set at Disable, the LTSSM state shift to L0s/L1 can be restricted, and the stability of the Link can be thereby enhanced.

FIG. 6 shows the examples of abnormal state shift patterns of the LTSSM which result from the return from the ASPM, and examples of the management methods of the abnormal state shifts, i.e. three examples of the shifts from L0s and three examples of the shifts from L1. However, the state shifts of the LTSSM do need to be limited to these. In FIG. 6, previous four LTSSM states are maintained. The shift information of these previous LTSSM state is stored in the storage means and employed as the database.

Finally, if more than a certain number of abnormal shifts occur on the basis of the above-described predetermined value, prohibition of the shift to ASPM (L0s/L1) can be determined (by setting the ASPM at Disable). At this time, the threshold value can be set freely.

If prohibition of the shift to ASPM is determined, the Link Control Register of the Configuration Register may be automatically set at Disable by the hardware or software. By restricting the ASPM shift, L0 can be maintained and the stable Link state can be maintained.

Even if the shift of the ASPM is once restricted, shift to the Recovery state, Configuration state and Detect state due to a temporary disturbance to the physical layer may be conceived. Thus, measurements of validating the ASPM again after elapse of a certain period or reducing the frequency of shifting to the L0s/L1 state as the shift of the ASPM, may be taken.

In a case of writing the Link Control Register by the software by setting the ASPM at Enable, the statistical information may be cleared to permit the shift to L0s/L1 again. Thus, various methods of settings can be applied to the present invention.

If the prohibition of the shift to ASPM (L0s/L1) is determined, Device ID, Vendor ID and the like of the connected device are preliminarily stored in the storage means. If a new device is connected and Device ID, Vendor ID and the like of the new device match the stored Device ID, Vendor ID and the like, the prohibition of the shift to ASPM (L0s/L1) can be determined.

If the Vendor ID alone of the new device matches the stored Vendor ID, both devices may be similar in settings. In this case, the prohibition of the shift to ASPM (L0s/L1) can be forcibly determined by lowering the threshold value of the abnormal shift.

In the above-described embodiment, the state shift at the LTSSM has been explained. Even if abnormality occurs in a layer higher than the Data Link Layer by the shift to the ASPM (L0s/L1), the abnormality may be detected by standards of a certain level and the transmission to the ASPM (L0s/L1) may be restricted similarly to the embodiment.

In addition, conformity with the standards of the PCI Express has been explained. However, the above-described embodiment can also be applied to a technique similar to the ASPM, i.e. a technique of automatically executing the Power Management.

Therefore, if the abnormal shift of the states is monitored and predetermined conditions are met as the abnormal shift, the state of the device can be prevented from being shifted to a certain state. In addition, if problems on compatibility with the device corresponding to the ASPM arise, stable connection can be maintained by automatically setting the ASPM at Disable.

The present invention has been accomplished to solve the above-described problems. The object of the present invention is to provide an information processing apparatus and a control method thereof capable of preventing a state of the device from being shifted to a certain state if abnormal shift of the states is monitored and predetermined conditions are met as the abnormal shift.

To solve the above-described problem, an embodiment of the present invention is an information processing apparatus comprising devices connected by a serial bus interface having a state machine shift for establishment of a communication path. The apparatus configured to comprise storage means for storing a state shift of the state machine as history information and control means for controlling a state of the state machine to be shifted to a specific state or not to be shifted thereto, in accordance with the history information.

For this reason, the present invention can prevent a state of the device from being shifted to a certain state if the abnormal shift of the states is monitored and predetermined conditions are met as the abnormal shift.

While certain embodiments of the inventions have been described, there embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising devices connected by a serial bus interface having a state machine shift for establishment of a communication path, the apparatus configured to comprise:
storage means for storing a state shift of the state machine as history information; and
control means for controlling a state of the state machine to be shifted to a specific state or not to be shifted thereto, in accordance with the history information.

2. The apparatus according to claim 1, wherein the history information is weighted in accordance with the state of the state machine and the specific state, and items of the weighted information are stored in the storage means as index information in association with one another.

3. The apparatus according to claim 1, wherein the specific state is a power saving mode.

4. The apparatus according to claim 2, wherein the control means controls the state of the state machine to be shifted to a specific state or not to be shifted thereto, in accordance with whether or not at least one number of times of accumulated abnormality occurrence of the state shift between the devices and the index information exceeds a predetermined value on the basis of the history information.

5. The apparatus according to claim 2, wherein the control means controls the state of the state machine to be shifted to a specific state or not to be shifted thereto, in accordance with whether or not a rate of the accumulated abnormality occurrence of the state shift between the devices or the index information exceeds a predetermined value on the basis of the history information.

6. The apparatus according to claim 5, wherein if at least one the rate of the accumulated abnormality occurrence of the state shift between the devices and the index information is lower than the predetermined value for a predetermined period on the basis of the history information, the control means permits the state of the state machine to be shifted to the specific state.

7. The apparatus according to claim 1, wherein the serial bus interface corresponds to PCI Express.

8. The apparatus according to claim 7, wherein if predetermined conditions are satisfied as a history in which shift and return to each of power states L0s and L1 in ASPM of PCI Express is an abnormal state shift, on the basis of the history information, the shift to the specific state is invalidated.

9. The apparatus according to claim 7, wherein if the shift to the specific state is forcibly permitted, the history in which the shift and return to each of the power states is an abnormal state shift, is cleared.

10. The apparatus according to claim 7, wherein if the shift to the specific state is invalidated, at least one the storage means stores device identification information and vendor identification information of devices connected at the time of invalidation and, if at least one a device corresponding to the device identification information and vendor identification information is connected, the shift to the specific state is invalidated.

11. The apparatus according to claim 7, wherein the storage means stores at least one kind of the number of times of the abnormality occurrence, the rate of the abnormality occurrence, and the index information, for each item of at least one device identification information and vendor identification information of a newly connected device and, if at least one a device corresponding to the device identification information and vendor identification information is connected, at least one kind of the information stored in the storage means is applied to the newly connected device.

12. A method of controlling operations of an information processing apparatus comprising devices connected by a serial bus interface having state machine shift for establishment of a communication path, the method comprising:
storing a state shift of the state machine as history information in storage means; and
controlling a state of the state machine to be shifted to a specific state or not to be shifted thereto, in accordance with the history information.

13. The method according to claim 12, wherein the history information is weighted in accordance with the state of the state machine and the specific state, and items of the weighted information are stored in the storage means as index information in association with one another.

14. The method according to claim 12, wherein the specific state is a power saving mode.

15. The method according to claim 12, wherein the serial bus interface corresponds to PCI Express.

16. The method according to claim 15, wherein the history information is weighted in accordance with the state of the state machine and the specific state, and items of the weighted information are stored in the storage means as index information in association with one another.

17. The method according to claim 15, wherein the specific state is a power saving mode.
